(19) United States
(12) Patent Application Publication
(10) Pub. No.: US 2025/0065276 A1
(43) Pub. Date: Feb. 27, 2025

(54) MEMBRANE FORMATION COMPOSITION, AND GAS PERMEATION MEMBRANE

(71) Applicant: NISSAN CHEMICAL CORPORATION, Tokyo (JP)

(72) Inventor: Kazutoshi ODAKA, Funabashi-shi (JP)

(73) Assignee: NISSAN CHEMICAL CORPORATION, Tokyo (JP)

(21) Appl. No.: 18/701,152

(22) PCT Filed: Oct. 18, 2022
(86) PCT No.: PCT/JP2022/038683

§ 371 Date: Apr. 12, 2024

(30) Foreign Application Priority Data
Oct. 22, 2021 (JP) 2021-173462

(51) Int. Cl. B01D 69/12; B01D 71/70

(52) U.S. Cl. CPC B01D 69/12; B01D 71/70

(57) ABSTRACT

A membrane-forming composition which comprises a silicone, a solvent for dissolving the silicone, and microparticles and which is used for forming a membrane through application onto a porous substrate, wherein the membrane-forming composition exhibits a permeation speed through the porous substrate of more than 0 μm/s^{0.5} and 100 μm/s^{0.5} or less, the permeation speed being determined by the Lucas-Washburn equation.

### TECHNICAL FIELD

The present invention relates to a membrane-forming composition containing silicone, a solvent for silicone, and surface-modified microparticles uniformly dispersed in the solvent for silicone, and to a gas separation membrane.

### BACKGROUND ART

Compositions containing a silicone resin and microparticles dispersed therein, and membrane products obtained from such compositions find use in a refractive index-regulating material, a semiconductor sealant, various separation materials, and many other materials. A key factor to maximally attain the characteristics of such materials is to attain a uniform dispersion state of the microparticles in the silicone resin. Thus, various dispersing techniques have been investigated. For example, there have been reported a technique including addition of a surfactant or a leveling agent, a technique including chemical modification of surfaces of particles, and other techniques (Patent Document 1).

Regarding such techniques, the present inventors previously found that dispersibility of particles in various resin matrices was enhanced through chemical modification of the surfaces of the particles (Patent Documents 2 and 3).

Meanwhile, it has been known that such microparticles having chemically modified surfaces fail to attain favorable dispersibility in some solvents. Particularly in the case of a silicone-soluble solvent, the dispersibility of such microparticles in the solvent is unsatisfactory. Therefore, when an attempt is made to disperse the surface-modified microparticles in silicone and a solvent for the silicone, aggregation or sedimentation occurs. As a result, membrane products obtained from such compositions have poor flatness, which is problematic.

In addition, as described in Patent Document 4, once particles surface-modified with a polymer or the like have been thoroughly dried, difficulty is encountered in re-dispersing the particles in silicone. Even in such a case, if appropriate means such as use of a dispersant and wet pulverization or the like is employed, the particles can be re-dispersed. However, more dispersion steps are required. In the case of silica microparticles, the microparticles cannot be completely crushed in most cases, and aggregates of the microparticles remain. Thus, employment of the surface modification technique is limited only to a gas separation membrane having a thickness of some hundreds of micrometers, which is also problematic.

Meanwhile, a gas separation membrane is formed by applying a membrane-forming composition containing silicone, a solvent for silicone, and particles dispersed therein onto a porous substrate. Thus, film-formability of the membrane-forming composition is also a key factor to determine the characteristics of the gas separation membrane formed from the composition.

### PRIOR ART DOCUMENTS

### Patent Documents

Patent Document 1: Japanese Patent Application Laid-Open (kokai) No 2017-119848
Patent Document 2: WO 2017/179738
Patent Document 3: WO 2018/038027
Patent Document 4: Japanese Patent Application Laid-Open (kokai) No 2012-224777

### SUMMARY OF THE INVENTION

### Problems to be Solved by the Invention

Even though such a membrane-forming composition is prepared by carefully controlling characteristics and compositional proportions of the silicone, the solvent, and the microparticles, the characteristics of the membrane formed from the membrane-forming composition vary considerably depending on the film-formability of the composition onto the substrate.

Under such circumstances, an object of the present invention is to provide a membrane-forming composition which can form a membrane having high flatness and no membrane defects. Another object is to provide a laminate which includes a membrane formed of the membrane-forming composition and disposed on a porous substrate. Still another object is to provide a method for producing the membrane-forming composition and a method for producing the laminate.

### Means for Solving the Problems

The present invention attaining the aforementioned objects includes the following modes.

In a first mode of the invention, there is provided a membrane-forming composition which comprises a silicone, a solvent for dissolving the silicone, and microparticles and which is used for forming a membrane through application onto a porous substrate, wherein the membrane-forming composition exhibits a permeation speed through the porous substrate of more than 0 μm/s^{0.55} and 100 μm/s^{0.5} or less, the permeation speed being determined by the Lucas-Washburn equation.

A second mode of the invention is directed to the membrane-forming composition of the first mode, which has a solid concentration of 10.0 mass % or less.

A third mode of the invention is directed to the membrane-forming composition of the first or second mode, wherein the porous substrate has a surface mean pore size of 0.01 μm to 1 μm.

A fourth mode of the invention is directed to the membrane-forming composition of any of the first to third modes, wherein the silicone is at least one species selected from among a silicone formed of a polydiorganosiloxane; a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent.

A fifth mode of the invention is directed to the membrane-forming composition of any of the first to fourth modes, which contains a component (A) as the silicone, a component (B) as the solvent, and a component (C) as the microparticles, and further contains a component (D), wherein the components (A) to (D) are as follows:
component (A): a silicone formed of a polydiorganosiloxane;
component (B): a solvent for dissolving the silicone;
component (C): surface-modified microparticles; and
component (D): at least one species selected from among a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent.

A sixth mode of the invention is directed to the membrane-forming composition of the fifth mode, which further contains, as a component (E), a particular solvent which is a compound having one or more oxygen or nitrogen atoms and which has a dielectric constant of 1 to 30.

A seventh mode of the invention is directed to the membrane-forming composition of the sixth mode, wherein the particular solvent is one or more solvents selected from the group consisting of a monohydric alcohol, a monoester, a monoketone, and an ether.

An eighth mode of the invention is directed to the membrane-forming composition of any one of the fifth to seventh modes, wherein the surface-modified microparticles are formed of silica.

A ninth mode of the invention is directed to the membrane-forming composition of the eighth mode, wherein the surface-modified microparticles are silica microparticles having a surface to which a dendrimer or a hyperbranched polymer has been added.

A tenth mode of the invention is directed to the membrane-forming composition of any of the fifth to ninth modes, wherein the component (B) is one or more solvents selected from the group consisting of a hydrocarbon solvent, an aromatic solvent, and an isoparaffin solvent.

An eleventh mode of the invention is directed to the membrane-forming composition of any of the first to tenth modes, which is a gas separation membrane-forming composition.

A twelfth mode of the invention is directed to the membrane-forming composition of any of the first to tenth modes, which is a composition for forming an intermediate layer used in a gas separation membrane.

A thirteenth mode of the invention provides a gas separation membrane formed by use of a membrane-forming composition as recited in any of the first to tenth modes.

In a fourteenth mode of the invention, there is provided a membrane-forming composition comprising the following components (A) to (D):
component (A): a silicone formed of a polydiorganosiloxane;
component (B): a solvent for dissolving the silicone;
component (C): surface-modified microparticles; and
component (D): at least one species selected from among a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent.

In a fifteenth mode of the invention, there is provided a laminate which includes a porous substrate and a membrane formed of the membrane-forming composition and disposed on the porous substrate, wherein the membrane is produced by applying the membrane-forming composition which comprises a silicone, a solvent for dissolving the silicone, and microparticles and which exhibits a permeation speed through the porous substrate of more than 0 μm/s^{0.5} and 100 m/s^{0.5} or less, the permeation speed being determined by the Lucas-Washburn equation.

In a sixteenth mode of the invention, there is provided a method for producing a membrane-forming composition which comprises a silicone, a solvent for dissolving the silicone, and microparticles and which is used for forming a membrane through application onto a porous substrate, wherein the permeation speed through the porous substrate, as determined by the Lucas-Washburn equation, is adjusted to be more than 0 μm/s^{0.5} and 100 μm/s^{0.5} or less.

In a seventeenth mode of the invention, there is provided a method for producing a laminate which includes a porous substrate and a membrane formed of a membrane-forming composition and disposed on the porous substrate, wherein the membrane is formed by applying a membrane-forming composition which comprises a silicone, a solvent for dissolving the silicone, and microparticles and which exhibits a permeation speed through the porous substrate of more than 0 μm/s^{0.5} and 100 μm/s^{0.5} or less, the permeation speed being determined by the Lucas-Washburn equation.

### Effects of the Invention

According to the present invention, there can be provided a membrane-forming composition which can form a membrane having high flatness and no membrane defects, and a laminate formed from the composition. In addition, a method for producing the membrane-forming composition and a method for producing the laminate can be provided.

### MODES FOR CARRYING OUT THE INVENTION

The present invention will next be described in detail.

The membrane-forming composition of the present invention is a membrane-forming composition which contains a silicone, a solvent for dissolving the silicone, and microparticles and which is used for forming a membrane through application onto a porous substrate. The membrane-forming composition exhibits a permeation speed through the porous substrate of more than 0 μm/s^{0.5} and 100 μm/s^{0.5} or less.

The permeation speed (1/t^{0.5}) is determined by the following equation.

1/t^{0.5}=(rγ cos θ/2η)⁰′5

The equation is based on the below-described equation, called the Lucas-Washburn equation, which has long been employed as a theoretical formula describing permeation of liquid through a substrate. The above permeation speed of the present invention is also referred to as Lucas-Washburn's permeation speed.

1=(trγ cos/2η)^{0.5}

(in the above equation, 1: permeation depth, r: capillary radius (pore radius of substrate), γ: surface tension of liquid, θ: contact angle of liquid on solid, η: viscosity of liquid, and t: time).

In the present invention, Lucas-Washburn's permeation speed is employed as a parameter which specifies the characteristics of the membrane-forming composition. Thus, a membrane-forming composition which can form a membrane having high flatness and no membrane defects can be provided, without individually specifying the characteristics of the membrane-forming composition, such as surface tension of the composition, viscosity of the composition, and contact angle of the composition with respect to a substrate.

In the present invention, the Lucas-Washburn's permeation speed through a porous substrate is preferably more than 0 μm/s^{0.55} and 100 μm/s^{0.5} or less, more preferably more than 0 μm/s^{0.55} and 60 μm/s^{0.5} or less. Through controlling the permeation speed, a membrane having high flatness and no membrane defect or failure can be formed.

In order to render the Lucas-Washburn's permeation speed of the membrane-forming composition through a porous substrate to fall within the aforementioned ranges, the species or proportions of the components of the membrane-forming composition must be appropriately adjusted so as to provide a suitable membrane-forming composition. Alternatively, the Lucas-Washburn's permeation speed of the membrane-forming composition through a porous substrate may be caused to fall within a specific range through an appropriate preliminary treatment of a porous substrate to which the composition is applied or another treatment.

In other words, in the membrane-forming composition production method of the present invention, the permeation speed through the porous substrate, as determined by the Lucas-Washburn equation, must be adjusted to be more than 0 μm/s^{0.5} and 100 μm/s^{0.5} or less, in preparation of a membrane-forming composition containing a silicone, a solvent for dissolving the silicone, and microparticles. The modulation of the permeation speed may be achieved through an appropriate tuning of the species or proportions of the components of the membrane-forming composition to thereby provide a suitable membrane-forming composition, or an appropriate preliminary treatment of a porous substrate to which the composition is applied or another treatment, or through both of them.

The silicone (component (A)) used in the present invention is one or more species selected from a condensation-type silicone and an addition-type silicone. The silicone used in the invention may be a silicone resin generally employed for forming a membrane, and is one or more species selected from a silicone formed of a polydiorganosiloxane, a condensation reaction product between a polydiorganosiloxane in which each end has been capped with a silanol group and a polyorganohydrogensiloxane cross-linking agent containing a hydrogen atom bonded to a silicon atom, and a cross-linked silicone formed by cross-linking a polydiorganosiloxane with a cross-linking agent.

As used herein, “silicone” is a polymer having a trunk formed of siloxane bonds. Silicon atoms joining the siloxane bonds may have a substituent. A general type of silicone is a polydiorganosiloxane having an organic substituent, and examples of the substituent include a methyl group and an ethyl group.

No particular limitation is imposed on the silicone, and specific examples include commercial silicone products such as Silicone YSR3022 and Silicone TSE382 (products of Momentive), KS-847T, KE44, KE45, KE441, and KE445 (products of Shin-Etsu Chemical Co., Ltd.), and SH780 and SE5007 (products of Toray Dow Corning), and a condensation reaction product obtained through condensation reaction of any of the commercial polydiorganosiloxanes with a cross-linking agent.

The above condensation reaction product has a relatively low cross-linking degree so as to ensure use instead of a general silicone.

No particular limitation is imposed on the solvent for dissolving silicone used in the present invention (component (B)), so long as the solvent can dissolve silicone. However, a solvent of low polarity is preferred. From the viewpoint of resistance to spontaneous evaporation at ambient temperature during membrane formation, the boiling point of the solvent is preferably 60 to 200° C. Specific examples include n-paraffins, isoparaffins, and aromatics (e.g., hexane, heptane, octane, isooctane, decane, nonane, cyclohexane, toluene, and xylene), and naphthene-type solvents. Of these, decane and nonane are preferred.

The solvent for dissolving silicone contained in the membrane-forming composition of the present invention is used in an amount of, for example, 100 to 5,000 parts by mass with respect to 100 parts by mass of silicone, preferably 500 to 2,000 parts by mass.

The microparticles used in the present invention (component (C)) are nanoparticles having a nano-order mean particle size. No particular limitation is imposed on the material of the microparticles, but inorganic microparticles are preferred. Notably, the term “nanoparticles” refers to particles having a mean primary particle size of 1 nm to 1,000 nm, particularly 2 nm to 500 nm. The mean primary particle size is determined through the nitrogen adsorption method (BET method).

Examples of the material of the inorganic microparticles include metal oxides such as silica, zirconia, ceria, titania, and alumina, and clay minerals such as phyllosilicate compounds. Among them, silica microparticles are preferred, with surface-modified silica microparticles being more preferred.

As silica microparticles, there may be employed spherical silica nanoparticles or irregularly shaped silica nanoparticles such as rod-like shape silica nanoparticles, beaded shape silica nanoparticles, and confeito-like (or rock candy-like) shape silica nanoparticles, to thereby provide a gas separation membrane having considerably improved gas permeance. As irregularly shaped silica nanoparticles, those disclosed in WO 2018-038027 may be used. Examples of such irregularly shaped silica nanoparticles include (1) rod-like shape silica nanoparticles, which have a ratio D1/D2 of ≥4, wherein D1 is a particle size determined through a dynamic light scattering method, and D2 is a particle size determined through the nitrogen gas adsorption method; which have a D1 of 40 to 500 nm; and which have a uniform diameter of 5 to 40 nm as observed under a transmission electron microscope; (2) beaded shape silica nanoparticles which are formed of colloidal silica spherical particles having a particle size D2 determined through the nitrogen gas adsorption method of 10 to 80 nm, and silica which binds together the colloidal silica spherical particles; which have a ratio D1/D2 of ≥3, wherein D1 is a particle size determined through the dynamic light scattering method, and D2 is a particle size of the colloidal silica spherical particles determined through the nitrogen gas adsorption method; which have a D1 of 40 to 500 nm; and which are formed of the colloidal silica spherical particles connected together; and (3) confeito-like shape silica nanoparticles which have a mean surface roughness S2/S3 of 1.2 to 10, wherein S2 is a specific surface area determined through the nitrogen gas adsorption method, and S3 is a specific surface area obtained by reducing a mean particle size D3 determined through image analysis; which have a D3 of 10 to 60 nm; and which have a plurality of wart-shaped projections on the surfaces thereof.

Notably, irregularly shaped silica nanoparticles are more preferably surface-modified, irregularly shaped silica nanoparticles which are obtained through surface modification of irregularly shaped silica nanoparticles.

Examples of the surface-modified silica microparticles preferred as the microparticles include surface modified, spherical silica nanoparticles obtained through surface modification of spherical silica nanoparticles, and surface-modified, irregularly shaped silica nanoparticles obtained through surface-modification of irregularly shaped silica nanoparticles (e.g., rod-like shape silica nanoparticles, beaded shape silica nanoparticles, and confeito-like shape silica nanoparticles). Both types are collectively referred to as “surface-modified silica microparticles” or “surface-modified silica nanoparticles.”

The surface-modified silica preferably has a surface onto which a functional group has been introduced. The functional group-introduced surface-modified silica may be formed by treating a silane compound having a hydrophilic group with silica under heating conditions. Examples of the silane compound having a hydrophilic group include aminopropyltriethoxysilane (APTES).

Examples of the surface-modified silica nanoparticles include silica nanoparticles having a surface to which a dendrimer or a hyperbranched polymer has been added. Next, the dendrimer- or hyperbranched polymer-added surface modified silica nanoparticles will be described in detail, with an example of production method therefor.

In the production of the dendrimer- or hyperbranched polymer-added surface modified silica microparticles, firstly, silica particles are dispersed in a first solvent and treated with a reactive functional group-containing compound having a functional group that reacts with a hyperbranch-forming monomer or a dendrimer-forming monomer. Through this treatment, the reactive functional group is added to the silica surface, whereby reactive functional group-modified silica nanoparticles are yielded. A preferred reactive functional group-containing compound is a silane coupling agent, for example, an amino group-terminated compound represented by formula (1):

### [F1]

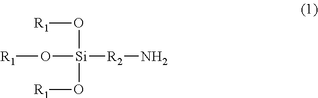

(wherein R₁ represents a methyl group or an ethyl group, R₂ represents an optionally substituted C1 to C5 alkylene group, an amido group, or an aminoalkylene group).

In the silane coupling agent represented by formula (1), the amino group is preferably bound to the end of the compound. However, the amino group may be bound to another position.

Examples of typical compounds represented by formula (1) include 3-aminopropyltriethoxysilane and 3-aminopropyltrimethoxysilane. Examples of the amino group-containing silane coupling agent include 3-ureidopropyltrimethoxysilane, 3-ureidopropyltriethoxysilane, 3-(2-aminoethylamino)propyltriethoxysilane, and 3-(2-aminoethylamino)propyltrimethoxysilane.

The reactive functional group-containing compound may have another group other than an amino group. Examples of such groups include an isocyanato group, a mercapto group, a glycidyl group, a ureido group, and a halogen group.

Examples of the silane coupling agent having a functional group other than an amino group include 3-isocyanatopropyltriethoxysilane, 3-mercaptopropylmethyldimethoxysilane, 3-mercaptopropyltrimethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-ureidopropyltriethoxysilane, and 3-chloropropyltrimethoxysilane.

The reactive functional group-containing compound used in the present invention is not necessarily a trialkoxysilane compound represented by formula (1). For example, the reactive functional group-containing compound may be a dialkoxysilane compound or a monoalkoxysilane compound.

The functional group of the reactive functional group-containing compound which group reacts with the silanol group of silica nanoparticles may be a group other than an alkoxy group, for example, an isocyanato group, a mercapto group, a glycidyl group, a ureido group, or a halogen atom.

In the treatment of silica nanoparticles with the reactive functional group-containing compound, the silica nanoparticles are dispersed in water or a C1 to C4 alcohol, and the reactive functional group-containing compound is added to the dispersion. The mixture is stirred.

As described above, chemical addition of reactive functional groups onto the surfaces of the silica nanoparticles may be carried out via a single-step reaction or, if required, a 2 or more-step reaction. A specific example of the 2-step reaction will be described in the preparation of carboxyl group-modified silica nanoparticles. Firstly, shaped silica nanoparticles are treated with aminoalkyltrialkoxysilane as described above, to thereby prepare amino group-modified silica nanoparticles. Subsequently, the amino group-modified silica nanoparticles are treated with a dicarboxylic acid compound represented by formula (2):

### [F2]

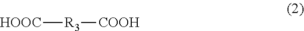

(wherein R₃ represents an optionally substituted C1 to C20 alkylene group or an optionally substituted C6 to C20 aromatic group) or an acid anhydride thereof, to thereby prepare reactive functional group-bound silica nanoparticles wherein the reactive functional group has a carboxyl group at its end.

Examples of the compound represented by formula (2) include malonic acid, adipic acid, and terephthalic acid. The dicarboxylic acid compound is not limited to those represented by formula (2).

In the case of bonding the reactive functional group to the surfaces of silica nanoparticles through a three or more-step reaction, a monomer represented by the following formula (3) (i.e., a monomer having amino groups at both terminals)

### [F3]

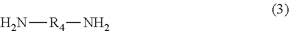

(wherein R₄ represents a C1 to C20 alkylene group or (C₂H₅—O—)ₚ and/or (C₃H₇—O—)_{q}, and each of p and q is an integer of ≥1) is bound to silica nanoparticles which have been treated with a compound represented by formula (1) and then with a compound represented by formula (2), to thereby prepare surface-modified silica nanoparticles, wherein the surface modification group has an amino group at its end. This reaction is repeated.

Examples of the monomer represented by formula (3) include ethylenediamine, polyoxyethylenebisamine (molecular weight: 2,000), and 0,0′-bis(2-aminopropyl)polypropylene glycol-block-polyethylene glycol (molecular weight: 500).

A subsequent reaction may be carried out after changing the solvent of the thus-prepared first solvent dispersion of the reactive functional group-modified silica nanoparticles to a second solvent.

The second solvent has hydrophobicity higher than that of the first solvent. The second solvent is preferably at least one species selected from among tetrahydrofuran (THF), N-methylpyrrolidone (NMP), 1,3-dimethyl-2-imidazolidinone (DMI), dimethylacetamide (DMAc), dimethylformamide (DMF), and γ-butyrolactone (GBL). The second solvent may be a solvent mixture.

No particular limitation is imposed on the method of substituting the first solvent by the second solvent. In one mode of substitution, a first solvent dispersion of the reactive functional group-modified silica nanoparticles is concentrated, and then the thus-obtained wet precipitates are re-dispersed in the second solvent. In an alternative mode, a first solvent dispersion of the reactive functional group-modified silica nanoparticles is not dried and is subjected to solvent substitution, wherein the second solvent is charged while the first solvent is distilled out.

After the above solvent substitution, the second solvent dispersion of the reactive functional group-modified silica nanoparticles is used. In the presence of the second solvent, a dendrimer or a hyperbranched polymer, having a multi-branched structure, is bound to the reactive functional group-modified silica nanoparticles. More specifically, a dendrimer-forming monomer or a hyperbranched polymer-forming monomer is reacted with the second solvent dispersion of the reactive functional group-modified silica nanoparticles, to thereby prepare silica nanoparticles to which the hyperbranched polymer or the dendrimer has been bound. Thus, a second solvent dispersion of the hyperbranched polymer- or dendrimer-bound silica nanoparticles is yielded.

The hyperbranched polymer-forming monomer used in the present invention is preferably a compound having one carboxyl group and two amino groups and represented by the following formula (4):

### [F4]

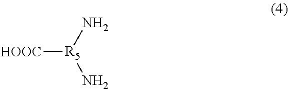

(wherein R₅ represents an optionally substituted C1 to C20 alkylene group or an optionally substituted C6 to C20 aromatic group) or may be such a compound having 3 or more amino groups. R₅ may be a group other than the C1 to C20 alkylene group or the C6 to C20 aromatic group. Examples of the hyperbranched polymer-forming monomer represented by formula (4) include 3,5-diaminobenzoic acid and 3,5-diamino-4-methylbenzoic acid.

Alternatively, the hyperbranched polymer-forming monomer used in the present invention may be a compound having one carboxyl group and two halogen atoms and represented by the following formula (5):

### [F5]

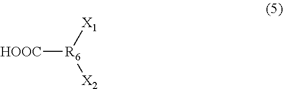

(wherein R₆ represents an optionally substituted C1 to C20 alkylene group or an optionally substituted C6 to C20 aromatic group, and each of X₁ and X₂ represents a halogen atom).

Examples of the compound represented by formula (5) include 3,5-dibromo-4-methylbenzoic acid, 3,5-dibromosalicylic acid, and 3,5-dibromo-4-hydroxy-benzoic acid.

The hyperbranched polymer-forming monomer is not limited to the aforementioned compound having one carboxyl group and two or more amino groups or having one carboxyl group and two or more halogen atoms. Any monomer capable of forming a hyperbranched polymer may be appropriately selected depending on the type of the reactive functional group of the modified silica nanoparticles.

In the case where the surfaces of silica nanoparticles are modified with a carboxyl group through a 2-step reaction, a hyperbranched polymer may be bound to the modified silica nanoparticles by use of a compound having one amino group and two carboxyl groups and represented by the following formula (6):

### [F6]

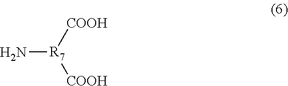

(wherein R₇ represents a C1 to C20 alkylene group or an optionally substituted C6 to C20 aromatic group).

Examples of the compound represented by formula (6) include 2-aminoterephthalic acid, 4-aminoterephthalic acid, and DL-2-aminosuberic acid.

As the hyperbranched polymer-forming monomer, there may be used an additional monomer having one amino group and two or more halogen atoms and represented by the following formula (7):

### [F7]

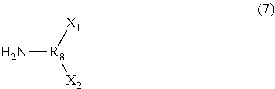

(wherein R₈ represents an optionally substituted C1 to C20 alkylene group or an optionally substituted C6 to C20 aromatic group, and each of X₁ and X₂ represents a halogen atom).

Examples of the compound represented by formula (7) include 3,5-dibromo-4-methylaniline and 2,4-dibromo-6-nitroaniline.

In the case of using the silica nanoparticles having surfaces modified with a carboxyl group through the aforementioned 2-step reaction, similar to the case of using the silica nanoparticles having surfaces modified with an amino group through the aforementioned 1-step reaction, the compounds of the formulas (6) and (7) may have two or more carboxyl groups or two or more halogen atoms, and an additional monomer having a functional group (other than an amino group) capable of reacting with a carboxyl group may be used.

The single polymer chain of the hyperbranched polymer formed through the aforementioned reaction preferably has a weight average molecular weight of, for example, about 200 to about 2,000,000, and preferably has a branching degree of about 0.5 to about 1.

In the reaction, the hyperbranched polymer-forming monomer is dissolved in the second solvent (i.e., one or more solvents selected from among tetrahydrofuran (THF), N-methylpyrrolidone (NMP), 1,3-dimethyl-2-imidazolidinone (DMI) dimethylacetamide (DMAc), dimethylformamide (DMF), and y-butyrolactone (GBL)); subsequently benzotriazol-1-yloxytris(dimethylamino)phosphonium hexafluorophosphate (BOP) (i.e., a carboxylic acid activating reagent) and triethylamine (i.e., a nucleophilic reagent) are added to the solution, and the mixture is agitated. Then, the amino group-modified silica nanoparticles are added to the mixture, and the resultant mixture is agitated. The aforementioned combination of BOP and triethylamine may be replaced with another combination. For example, the carboxylic acid activating reagent may be triphenylphosphine, and the nucleophilic reagent may be pyridine.

Dendrimer-bound silica nanoparticles will next be described. Now will be described addition of a dendrimer to amino group-modified silica nanoparticles.

In the present invention, for addition of a dendrimer to amino group-modified silica nanoparticles of the present invention, a monomer represented by the following formula (8) (e.g., a monomer having three carboxyl groups) or a monomer having four or more carboxyl groups must be bound to the amino group-modified silica nanoparticles. Examples of the monomer used include trimesic acid and pyromellitic acid.

### [F8]

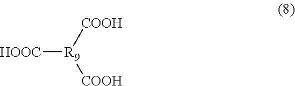

(In formula (8), R₉ represents an optionally substituted C1 to C20 alkylene group or an optionally substituted C6 to C20 aromatic group.)

The aforementioned addition of a monomer having three carboxyl groups or a monomer having four or more carboxyl groups is followed by addition of a monomer having two amino groups at both terminals and represented by the following formula (3):

### [F9]

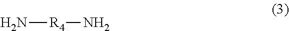

(wherein R₄ represents a C1 to C20 alkylene group or (C₂H₅—O—)ₚ and/or (C₃H₇—O—)_{q}, and each of p and q is an integer of ≥1). Through repetition of such addition steps, dendrimer-modified silica nanoparticles are prepared.

In the case of using the silica nanoparticles modified with a carboxyl group (i.e., a functional group) through the aforementioned 2-step reaction, the carboxyl group-modified silica nanoparticles are treated with a monomer having three amino groups or a monomer having four or more amino groups and represented by the following formula (9):

### [F10]

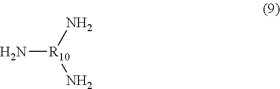

(wherein R₁₀ represents an optionally substituted C1 to C20 alkylene group or an optionally substituted C6 to C20 aromatic group). Examples of the monomer having three amino groups include 1,2,5-pentanetriamine, and examples of the monomer having four or more amino groups include 1,2,4,5-benzenetetraamine.

Subsequently, a monomer having two terminal carboxyl groups and represented by the following formula (10):

### [F11]

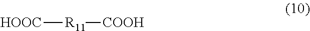

(wherein R₁₁ represents a C1 to C20 alkylene group, or (C₂H₅O—)ₚ and/or (C₃H₇—O—)_{q}, and each of p and q is an integer of ≥1) is bound to the resultant silica nanoparticles. Examples of the monomer include succinic acid, levulinic acid, and O,O′-bis[2-(succinylamino)ethyl]polyethylene glycol (molecular weight: 2,000).

This addition is repeated to thereby prepare silica nanoparticles having surfaces modified with a dendrimer. The dendrimer-forming monomer may have a group other than an amino group or a carboxyl group.

The thus-prepared hyperbranched polymer- or dendrimer-bound, surface-modified silica nanoparticles are used to form a membrane-forming composition. Finally, the composition is formed into a membrane. Notably, the hyperbranched polymer- or dendrimer-bound silica nanoparticles may be dried, before mixing of silica nanoparticles to form a membrane-forming composition. Alternatively, at least a portion of the second solvent may be replaced with another second solvent or a solvent other than the second solvent.

In the membrane-forming composition of the present invention, the ratio by mass of silicone to microparticles is, for example, 99.9/0.1 to 80/20, preferably 99.9/0.1 to 90/10, more preferably 99.5/0.5 to 92/8.

The membrane-forming composition of the present invention preferably contains at least one species selected from among a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent (component (D)).

When the polydiorganosiloxane in which each end has been capped with a silanol group (i.e., a silanol group-capped polydiorganosiloxane) is condensed with a polyorganohydrogensiloxane cross-linking agent containing a hydrogen atom bonded to a silicon atom, 3-dimensional cross-linking occurs, to thereby yield a condensation reaction product having a 3-dimensional network structure. The condensation reaction product is used as an alternative agent to a generally employed viscosity-regulating agent, to thereby elevate the viscosity of the membrane-forming composition. Also, the condensation reaction product has an essential structure similar to that of polydiorganosiloxane, and thus is advantageous, in that the viscosity of the composition can be elevated without changing basic characteristics of the composition.

In the present invention, a polyorganohydrogensiloxane containing a hydrogen atom bonded to a silicon atom has a structure including, in one molecule, at least two structural units each containing a hydrogen atom bonded to a silicon atom. These structural units are mutually linked by another structural unit not containing a hydrogen atom bonded to a silicon atom. Through condensation reaction between a silicon atom to which a hydrogen atom is bonded and silanol groups at both ends of the silanol group-capped polydiorganosiloxane, a 3-dimensional cross-linking structure is formed.

The solid concentration of the membrane-forming composition of the present invention is preferably 10.0 mass % or less, since an excessively high solid concentration evokes aggregation of particles in the membrane during formation thereof.

As used herein, the solid content refers to a component other than the solvent in the membrane-forming composition. The solid concentration refers to a ratio of the mass of the solid content to the entire mass of the membrane-forming composition.

The numerical range of the solid concentration of the membrane-forming composition of the present invention cannot be limited exactly, since the concentration must be appropriately adjusted in accordance with the application method and the target membrane thickness. In the case where gravure coating is employed as the application method, and the target membrane thickness in dry state is some micrometers, the solid concentration of the membrane-forming composition is, for example, 1 to 10 parts by mass, preferably 1 to 7.5 parts by mass, more preferably 1 to 6.5 parts by mass.

The viscosity of the membrane-forming composition of the present invention is, for example, 1 to 200 mPa-s, preferably 10 to 100 mPa-s, more preferably 30 to 80 mPa-s.

Meanwhile, the membrane-forming composition of the present invention may also contain various additives for the purpose of controlling membrane formability. For example, from the viewpoints of drying and curing speed, there may be added one or more particular solvents each being a compound which has one or more oxygen or nitrogen atoms and which has a dielectric constant of 1 to 30 (i.e., component (E)). These solvents may be the same as those for dissolving silicone. As used herein, the term “dielectric constant” refers to a ratio of permittivity of a solvent to that of vacuum. The dielectric constants of various solvents are disclosed in the reference (National Bureau of Standards Circular 514, 1951).

Regarding the particular solvent which is a compound having one or more oxygen or nitrogen atoms and which has a dielectric constant of 1 to 30, the dielectric constant is preferably 1 to 25, more preferably 1 to 20. No particular limitation is imposed on the particular solvent, and examples of preferred members include a monohydric alcohol, a monoether, a monoester, and a monoketone, each having a hydrocarbon main chain. In particular, specific examples include n-hexanol, n-heptanol, 4-heptanol, n-butanol, isopropanol, cyclohexanol, tetrahydrofuran (THF), propylene glycol monomethyl ether (PGME), cyclopentanone, and a mixture of two or more members thereof.

So long as the membrane formability is not impaired, the amount of any of the above additives is 0.01 to 50.0 parts by mass, with respect to the amount of the composition excluding the additives as 100 parts by mass, preferably 0.1 to 30.0 parts by mass, particularly preferably 0.1 to 10.0 parts by mass, more preferably 0.1 to 5.0 parts by mass.

The membrane-forming composition may contain a cross-linking agent for silicone in combination with other components. The cross-linking agent is used for elevating cross-linking density and enhancing heat resistance and durability. For example, when a hydroxyl-terminated silicone is used, a silane compound having a plurality of hydrolyzable functional groups or a partial hydrolysis/condensation product thereof may be used as a cross-linking agent. Specific examples of the silane compound include, but are not limited to, oximesilanes such as methyltris(diethylketoxime)silane, methyltris(methylethylketoxime)silane, vinyltris(methylethylketoxime)silane, and pheyltris(diethylketoxime)silane; alkoxysilanes such as methyltrimethoxysilane, methyltriethoxysilane, vinyltrimethoxysilane, vinyltriethoxysilane, phenyltrimethoxysilane, tetramethoxysilane, and tetraethoxysilane; acetoxysilanes such as methyltriacetoxysilane and ethyltriacetoxysilane; aminophenyltriethoxysilane-type silanes such as methyltris(dimethylamino)silane, methyltris(diethylamino)silane, methyltris(N-methylacetamido)silane, and vinyltris(N-ethylacetamido)silane; and aminoxysilanes such as methyltris(dimethylaminoxy)silane and methyltris(diethylaminoxy)silane. In the case of additionally using a cross-linking agent, the amount of the cross-linking agent is preferably about 0.01 mass % to about 20 mass %, with respect to silicone.

The membrane-forming composition of the present invention preferably employs, as a hardening agent, a condensation reaction catalyst or an addition reaction catalyst. As such catalyst, a tin compound, a titanium compound, a platinum compound, an alkali metal compound, etc., which are generally used as a catalyst, may be used. These catalyst may be used singly or in combination of two or more species.

The amount of the aforementioned catalyst(s) is 0.1 to 30 parts by mass, with respect to 100 parts by mass of silicone, preferably 0.1 to 20 parts by mass, more preferably 1 to 15 parts by mass.

Into the membrane-forming composition of the present invention, there may be incorporated a cross-linked silicone formed by cross-linking a polydiorganosiloxane with a cross-linking agent, or a condensation reaction product between a polydiorganosiloxane in which each end has been capped with a silanol group and a polyorganohydrogensiloxane cross-linking agent containing a hydrogen atom bonded to a silicon atom. The cross-linked silicone and the condensation reaction product used herein have a cross-linking degree lower than that of the aforementioned component (D) and thus is not considerably effective on an increase in viscosity. Notably, whether the relevant product serves as the component (A) or (D) depends on the cross-linking degree. No particular boundary for treating the product as the component (A) or (D) is employed. However, whether the relevant product serves as the component (A) or (D) is not particularly important issue, and viscosity and other characteristics of the membrane-forming composition are important instead.

The membrane-forming composition of the present invention readily achieves a favorable dispersion state by agitation means such as a mixer. If needed, ultrasonication, a wet jet-mill treatment, a wet bead-mill treatment, a high-pressure homogenizer treatment, and the like may be performed. Through such an additional treatment, the dispersion state is further enhanced.

In the membrane production method, the aforementioned composition is applied onto a substrate, and the solvents are evaporated. No particular limitation is imposed on the material of the porous substrate to which the composition is applied, so long as the substrate is not deteriorated by the solvent. Examples of the material of a substrate having pores on the surface include polyether-sulfone (PES), polysulfone (PSF), polypropylene (PP), polyethylene (PE), polytetrafluoroethylene (PTFE), polyethylene terephthalate (PET), polyacrylonitrile (PAN), polyimide, polyamide, cellulose acetate, triacetate, polyacrylonitrile, and epoxy resin.

No particular limitation is imposed on the pore size of the porous substrate. For example, in the case of a porous substrate used in a gas separation membrane, the prose size is preferably 0.01 μm to 1 μm, more preferably 0.02 μm to 0.50 μm, most preferably 0.025 μm to 0.20 μm, from the viewpoint of gas permeance and applicability (coatability).

The application method is preferably a method which can attain uniform coating on a substrate. No particular limitation is imposed on the application method, and there may be employed known coating methods and techniques including dip coating (immersion), spin coating, blade coating, spray coating, bar coater coating, microgravure coating, gravure coating, and slot die coating. Among them, blade coating is preferred, with doctor blade coating being particularly preferred.

The present invention will next be described in detail by way of examples, which should not be construed as limiting the invention thereto.

### EXAMPLES

### [Synthesis of Surface-Modified Silica ST-G1]

To a four-neck, round-bottom flask (1,000 mL) equipped with a condenser, a thermometer, and an agitator, there were added a silica dispersion in isopropanol (IPA) (IPA-ST, product of Nissan Chemical Corporation, silica concentration: 30.5 mass %, mean primary particle size: 12 nm) (491.80 g), ultrapure water (2.69 g), and IPA (2494.5 g), and the mixture was heated to reflux under agitation. Thereafter, APTES (product of Tokyo Chemical Industry Co., Ltd.) (11.03 g) was added thereto, and the resultant mixture was agitated for 1 hour under reflux, to thereby prepare a dispersion. While IPA and water were removed from the obtained dispersion by means of an evaporator, 1-methyl-2-pyrrolidone (M4P) was added. The water content of the solution was confirmed by means of a Karl Fischer moisture meter. When the water content reached 0.1 mass % or less, this operation was stopped. Thereafter, the APTES-modified silica content was adjusted to about 5.4 mass % by use of NMP. The thus-obtained solution was employed as an ST-G0-NMP sol.

To a four-neck, round-bottom flask (1,000 mL) equipped with a condenser, a thermometer, and an agitator, there were added the ST-G0-NMP sol (the entire amount), 1,3-diaminobenzoic acid (DABA) (product of Aldrich) (22.75 g), triethylamine (TEA) (product of Kanto Chemical Co., Inc.) (15.13 g), and benzotriazol-1-yloxytris(dimethylamino)phosphonium hexafluorophosphate (BOP) (product of Tokyo Chemical Industry Co., Ltd.) (66.12 g), and the mixture was agitated at room temperature for 5 minutes. The mixture was heated at 80° C. and allowed to react for 1 hour. The thus-obtained reaction mixture was filtered through filter paper (pore size: 7 μm), and the filtrate was added to a 9-fold volume (with respect to the reaction mixture) of methanol, followed by allowing the mixture to stand. Subsequently, the supernatant was removed, and the equiamount of methanol was added again. The resultant mixture was stirred and allowed to stand. The washing procedure was performed five times in total to complete. The thus-yielded solution was employed as ST-G1-methanol dispersion.

### [Preparation of Master Batch: Preparation of ST-G1/Silicone Dispersion]

Silicone YSR3022 (product of Momentive, solvent: toluene, methyl ethyl ketone, solid content: 30 mass %, containing polyorganohydrogensiloxane cross-linking agent as an additive) and ST-G1-methanol dispersion were added to an eggplant-shaped flask, so that the ratio by mass of silicone to ST-G1 was adjusted to 9/1. Subsequently, toluene in an amount equivalent to that of ST-G1-methanol dispersion was added, and the mixture was stirred. Then, toluene was removed by means of an evaporator to such an extent that the solvent was not completely removed. Next, decane was added, and remaining toluene was distilled out. Finally, the dispersion concentration was adjusted to about 10 mass %. Notably, the dispersion concentration is defined as the total solid concentration of silicone and ST-G1.

### [Preparation of Silicone-Decane Mixed Solution]

Silicone YSR3022 (product of Momentive) (98.36 g) and decane (270.0 g) were added to a 1-L eggplant-shaped flask, and then decane was distilled out by means of an evaporator. The final silicone concentration was adjusted to 10 mass %. The relative amount of toluene in the mixed solution was found to be 1 mass % or less as determined through ¹H-NMR spectrometry on the basis of a ratio of the number of protons of dimethylsilicone to that of all the protons of the aromatic ring of toluene.

### [Component (D)-1: Preparation of Condensation Reaction Product 1-Decane Mixed Solution]

To the above-prepared silicone-decane mixed solution (3 g), there were added a hardening agent YC6831 (product of Momentive, solvent: toluene, dibutyltin diacetate content: 37.5 mass %) (7 parts by mass with respect to 100 parts by mass of silicone). The mixture was allowed to react at room temperature for 30 minutes. Thereafter, the reaction mixture was 3-fold diluted with decane, and the resultant mixture was further reacted for 1 hour, to thereby yield a condensation reaction product 1-decane mixed solution. The E-type viscosity of the mixed solution was 136 mPa-s at a shear rate is-1.

### [Component (D)-2: Preparation of Condensation Reaction Product 2-Decane Mixed Solution]

The same preparation conditions were employed, except that the time of reaction at room temperature in (D)-1 was changed to 20 minutes, to thereby yield a condensation reaction product 2-decane mixed solution. The E-type viscosity of the mixed solution was 66.9 mPa-s.

### [Component (D)-3: Preparation of Condensation Reaction Product 3-Decane Mixed Solution]

The same preparation conditions were employed, except that the time of reaction at room temperature in (D)-1 was changed to 15 minutes, to thereby yield a condensation reaction product 3-decane mixed solution. The E-type viscosity of the mixed solution was 58.4 mPa-s.

### [Component (D)-4: Preparation of Condensation Reaction Product 4-Decane Mixed Solution]

To the above-prepared silicone-decane mixed solution (10.0 g), there were added a hardening agent YC6831 (product of Momentive, solvent: toluene, dibutyltin acetate content: 37.5 mass %) (7 parts by mass with respect to 100 parts by mass of silicone). The mixture was allowed to react at room temperature for 20 minutes. Thereafter, the reaction mixture was diluted with decane (1.80 g) and octane (4.63 g) and the resultant mixture was further reacted for 30 minutes, to thereby yield a condensation reaction product 4-/octane/decane mixed solution (mass ratio: 1/2.33). The E-type viscosity of the mixed solution was 2,560 mPa-s or higher (outside the measurable range).

### [Preparation of Membrane-Forming Composition]

Each of the above-prepared mixed solutions and reagents were used at compositional proportions shown in Table 1, to thereby prepare a membrane-forming composition. The E-type viscosity, contact angle to a substrate, and surface tension of each membrane-forming composition were measured through the following conditions.

TABLE 1

| | Compn. | Compn. | Compn. | Compn. | Compn. |
|---|---|---|---|---|---|
| | 1 | 2 | 3 | 4 | 5 |
| Solid conc. (mass %) | 6.5 | 6.5 | 6.5 | 2.5 | 5.0 |
| ST-G1 (mass parts) | 11.1 | 11.1 | 11.1 | 11.1 | 11.1 |
| Silicone (mass parts) | 100 | 100 | 100 | 100 | 100 |
| Product 1 (mass parts) | 33.3 | — | — | — | — |
| Product 2 (mass parts) | — | 33.3 | — | — | — |
| Product 3 (mass parts) | — | — | 33.3 | — | — |
| n-Heptanol (mass parts) | 111 | 111 | 111 | 111 | 111 |
| Decane (mass parts) | 1,967 | 1,967 | 1,967 | 4,222 | 2,000 |
| YC6831 (mass parts) | 21 | 21 | 21 | — | — |

Compn.: Membrane-forming composition
Product: Condensation reaction product

[E-type viscosity measurement]

E-type viscosity was measured by means of a viscometer TV-22 or TV-25 (products of Tokisangyo). Specifically, a membrane-forming composition (about 1 mL) was put into a sample cup and maintained for 2 minutes under shear force by means of a cone plate rotor at a shear rate of 76.6 s⁻¹. After achievement of consistent viscosity, the value was employed as the viscosity. The measurement was conducted at 25° C.

### [Contact Angle Measurement]

The contact angle was measured by means of a contact angle meter DM301 (product of Kyowa Interface Science Co., Ltd.). Specifically, a liquid drop (about 1 μL) of a membrane-forming composition was deposited on a non-porous film made of the same material as that of a porous substrate which was used as an actual coating substrate. Three seconds thereafter, the contact angle was measured. In the contact angle measurement, the following non-porous films were used. Polyether sulfone: Type: SU301025, product of Good Fellow Polysulfone: Type: Udel® P-1700NT-11, product of SOLVAY Polytetrafluoroethylene (PTFE): PTFE sheet, Nichias Corporation

### [Surface Tension Measurement]

The surface tension was measured by means of a surface tension meter DY-700 (product of Kyowa Interface Science Co., Ltd.) at room temperature through the Wilhelmy method. A probe (gauge head) made of a glass plate (i.e., a manufacture's genuine product) was employed.

### [Measurement of Pore Size of Porous Substrate]

The surface of a porous substrate was observed under an electron microscope. Thirty or more pores were selected, and the measured values were averaged.

Apparatus: JSM-7800F, prime (product of JEOL), acceleration voltage: 0.7 kV

Preliminary treatment: Before electron microscope observation, antistatic treatment by coating the porous substrate with Pt coating (thickness; about 1 nm), and stacked onto carbon tape.

### [Permeation Speed of Membrane-Forming Composition Through Substrate]

The permeation speed of each membrane-forming composition was calculated by inputting parameters into the Lucas-Washburn equation.

### Examples 1 to 5 and Comparative Examples 1 to 4

Each of the prepared membrane-forming compositions was applied onto various substrates fixed on PET film by means of an applicator having a gap adjusted to 100 μm. The application speed was 4 m/min. Subsequently, each composition-coated substrate was dried by an oven at 120° C. for 30 minutes. The thus-obtained membrane was assessed in terms of membrane defect and membrane failure. Table 2 shows the results.

### [Type of Porous Substrates and Preliminary Treatment Before Application]

The following porous substrates were employed, and the following preliminary treatments were performed.

Porous substrate 1: product of Merck, material: polyether sulfone

Product name: Biomax® (registered trademark) 300 kDa

Preliminary treatment conditions: Twice washing by immersing in water/methanol=1/1 (mass ratio), and natural drying, to thereby remove a filler which prevents clogging of pores of the membrane

Porous substrate 2: product of Toyo Cloth Co., Ltd., material: polyether sulfone

Preliminary treatment conditions: none

Porous substrate 3: product of Nitto Denko Corporation, material: polysulfone, product name: Type CF-30

Preliminary treatment conditions: Twice washing by immersing in water/methanol=1/1 (mass ratio), and natural drying, to thereby remove a filler which prevents clogging of pores of the membrane

Porous substrate 4: product of Sumitomo Electric Industries, Ltd., material: polytetrafluoroethylene, product name: FP-010-60STD

Preliminary treatment conditions: none

### [Membrane Defect Assessment Method]

Isopropanol (IPA) (about 10 μL) was added dropwise to the thus-obtained coated membrane. Permeation feature was visually observed, to thereby assess the presence of membrane defects on the basis of the following ratings.

◯: No permeation of IPA within a period of 30 seconds

X: No IPA remaining on the membrane after 30 seconds

### [Membrane Failure Assessment Method]

Next, the coated membrane was subjected to a finger touch test. In a specific procedure, the surface of the membrane was scrubbed by fingers five times reciprocally, while the load was controlled to 20 to 70 g by monitoring with a balance. Membrane failure was assessed through visual observation.

◯: No failure observed in membrane

X: Failure observed in membrane

In Examples 1 to 5 (permeation speed of 100 μm/s^{0.5} or less), a membrane having no defect and failure was successfully formed. In contrast, in Comparative Examples 1 to 4 (permeation speed more than 100 μm/s^{0.5}), no membrane was formed.

Thus, the above tests have confirmed that the applicability (coatability) of the composition to the porous substrate does not depend on the material of the substrate; and the composition exhibiting a permeation speed of 100 μm/s° or less through the porous substrate and having a solid concentration of 7.0 mass % or less can provide excellent coatability and form a membrane having no defect or failure. When a composition not satisfying the above conditions is used, a membrane having defects or undesired failure is formed, conceivably due to aggregation of particles and a small thickness of the formed membrane.

TABLE 2

| | | Ex. 1 | Ex. 2 | Ex. 3 | Ex. 4 | Ex. 5 | Comp. 1 | Comp. 2 | Comp. 3 | Comp. 4 |
|---|---|---|---|---|---|---|---|---|---|---|
| Composition used | | Compn. 1 | Compn. 2 | Compn. 1 | Compn. 3 | Compn. 1 | Compn. 5 | Compn. 3 | Compn. 4 | Compn. 5 |
| Solid content (mass %) | | ~6.5 | ~5.5 | ~6.5 | ~6.5 | ~6.5 | ~5.0 | ~6.5 | ~2.5 | ~5.0 |
| E-type viscosity (mPa · s) | | 62.5 | 60.1 | 62.5 | 52.9 | 62.5 | 13 | 52.9 | 4.0 | 13 |
| Contact angle/PES (°) | | 15.1 | 14.2 | 15.1 | 14.4 | — | 9.6 | 14.4 | 10.2 | — |
| Contact angle/PSf (°) | | — | — | — | — | 11.3 | — | — | — | 6.8 |
| Surface tension (mN) | | 23.5 | 23.9 | 23.5 | 23.9 | 23.5 | 22.4 | 23.9 | 23.8 | 22.4 |
| Substrate | Substrate 1 | 102 | 102 | — | — | — | 102 | 102 | — | — |
| pore size | Substrate 2 | — | — | 29 | 29 | — | — | — | 29 | — |
| (nm) | Substrate 3 | | — | — | — | 47 | — | — | | 47 |

| | | | | | | | | | |
|---|---|---|---|---|---|---|---|---|---|
| Liq. permeation rate | 96 | 99 | 50 | 55 | 65 | 208 | 106 | 203 | 260 |
| (μm · s^{-0.5}) | | | | | | | | | |
| Defects | ◯ | ◯ | ◯ | ◯ | ◯ | X | X | X | X |
| Failure | ◯ | ◯ | ◯ | ◯ | ◯ | X | X | X | X |

Compn.: Membrane-forming composition
Substrate: porous substrate
~: about

### Example 6

A membrane-forming composition 6 having compositional proportions shown in Table 3 was prepared in a manner similar to Examples 1 to 5. The thus-prepared membrane-forming compositions was applied onto the porous substrate 1 fixed on PET film by means of an applicator (GAP: 30 μm, application speed: 4 m/min). The composition-coated substrate was dried by an oven at 120° C. for 30 minutes, to thereby produce a coated membrane. The thus-obtained laminate was subjected to a gas permeation test.

TABLE 3

| | Membrane-forming |
|---|---|
| Components | composition 6 |
| Solid concn. (mass %) | 6.5 |
| ST-G1 (mass parts) | 11 |
| Silicone (mass parts) | 100 |
| Condensation product 4 (mass parts) | 444 |
| n-Heptanol (mass parts) | 111 |
| Decane (mass parts) | 5,800 |
| Octane (mass parts) | 2,058 |
| YC6831 (mass parts) | 31 |

### Example 7

A laminate was fabricated under the same conditions as employed in Example 6, except that the porous substrate 1 was changed to a porous substrate 4. The laminate was subjected to a plurality of tests.

### [Gas Permeation Test]

CO₂ gas permeance and N₂ gas permeance were measured through a differential pressure method (1 atm, 35° C.) by means of GTR-6ADF (product of GTR Tec Corporation). A measurement sample was prepared by masking the coated membrane with aluminum seal so as to provide a circular form coated surface having an area of 0.196 cm². In one trial of measurement, evacuation of the measurement cell was conducted for about 7 minutes, and the gas permeation amount after feeding a gas of interest was measured for about 3 seconds. The set of operations was repeated 4 times in total. The gas permeation amount at the 4th trial was employed as a gas permeation amount of the Examples. The measurement procedure was twice carried out on one laminate, and the measurements were averaged.

Table 4 shows the results of the gas permeation test. As is clear from Table 4, the laminates fabricated in Examples 6 and 7 were found to exhibit excellent gas selectivity and to effectively serve as a gas separation membrane.

Notably, the unit “GPU” in Table 4 is derived from the following formula:

1GPU=1×10⁻⁶ cm³ (STP)/(scm²·cmHg), wherein and “cm³ (STP)” represents a volume of gas at 1 atm and 0° C.

TABLE 4

| | | Ex. 6 | Ex. 7 |
|---|---|---|---|
| Composition used | | Compn. 6 | Compn. 6 |
| Solid conc. (mass %) | | about 6.5 | about 6.5 |
| E-type viscosity (mPa · s) | | 552 | 552 |
| Contact angle/PES (°) | | 31.2 | — |
| Contact angle/PTEF (°) | | — | 18.6 |
| Surface tension (mN) | | 26.2 | 26.2 |
| Substrate pore size | Substrate 1 | 102 | — |
| (nm) | Substrate 4 | — | 626 |

| | | |
|---|---|---|
| Liq. permeation rate | 32.2 | 83.9 |
| (μm · s^{-0.5}) | | |
| Membrane defects | ○ | ○ |
| Membrane failure | ○ | ○ |
| CO₂ permeance (GPU) | 8,940 | 1,750 |
| CO₂/N₂ selectivity | 4.0 | 5.1 |

Compn.: Membrane-forming composition
Substrate: porous substrate

1. A membrane-forming composition which comprises a silicone, a solvent for dissolving the silicone, and microparticles and which is used for forming a membrane through application onto a porous substrate, wherein the membrane-forming composition exhibits a permeation speed through the porous substrate of more than 0 μm/s^{0.5} and 100 μm/s^{0.5} or less, the permeation speed being determined by the Lucas-Washburn equation.

2. A membrane-forming composition according to claim 1, which has a solid concentration of 10.0 mass % or less.

3. A membrane-forming composition according to claim 1 or 2, wherein the porous substrate has a surface mean pore size of 0.01 μm to 1 μm.

4. A membrane-forming composition according to any one of claims 1 to 3, wherein the silicone is at least one species selected from among a silicone formed of a polydiorganosiloxane; a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent.

5. A membrane-forming composition according to any one of claims 1 to 4, which contains a component (A) as the silicone, a component (B) as the solvent, and a component (C) as the microparticles, and further contains a component (D), wherein the components (A) to (D) are as follows:
component (A): a silicone formed of a polydiorganosiloxane;
component (B): a solvent for dissolving the silicone;
component (C): surface-modified microparticles; and
component (D): at least one species selected from among a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent.

6. A membrane-forming composition according to claim 5, which further contains, as a component (E), a particular solvent which is a compound having one or more oxygen or nitrogen atoms and which has a dielectric constant of 1 to 30.

7. A membrane-forming composition according to claim 6, wherein the particular solvent is one or more solvents selected from the group consisting of a monohydric alcohol, a monoester, a monoketone, and an ether.

8. A membrane-forming composition according to any one of claims 5 to 7, wherein the surface-modified microparticles are formed of silica.

9. A membrane-forming composition according to claim 8, wherein the surface-modified microparticles are silica microparticles having a surface to which a dendrimer or a hyperbranched polymer has been added.

10. A membrane-forming composition according to any one of claims 5 to 9, wherein the component (B) is one or more solvents selected from the group consisting of a hydrocarbon solvent, an aromatic solvent, and an isoparaffin solvent.

11. A membrane-forming composition according to any one of claims 1 to 10, which is a gas separation membrane-forming composition.

12. A membrane-forming composition according to any one of claims 1 to 10, which is a composition for forming an intermediate layer used in a gas separation membrane.

13. A gas separation membrane formed by use of a membrane-forming composition as recited in any one of claims 1 to 10.

14. A membrane-forming composition comprising the following components (A) to (D):
component (A): a silicone formed of a polydiorganosiloxane;
component (B): a solvent for dissolving the silicone;
component (C): surface-modified microparticles; and
component (D): at least one species selected from among a condensation reaction product between a polydiorganosiloxane in which each end has been capped with a silanol group and a polyorganohydrogensiloxane cross-linking agent containing a hydrogen atom bonded to a silicon atom; and a cross-linked silicone formed by cross-linking a polydiorganosiloxane with a cross-linking agent.

15. A laminate which includes a porous substrate and a membrane formed of a membrane-forming composition and disposed on the porous substrate, wherein the membrane is produced by applying the membrane-forming composition which comprises a silicone, a solvent for dissolving the silicone, and microparticles and which exhibits a permeation speed through the porous substrate of more than 0 μm/s^{0.5} and 100 μm/s^{0.5} or less, the permeation speed being determined by the Lucas-Washburn equation.

16. A method for producing a membrane-forming composition which comprises a silicone, a solvent for dissolving the silicone, and microparticles and which is used for forming a membrane through application onto a porous substrate, wherein the permeation speed through the porous substrate, as determined by the Lucas-Washburn equation, is adjusted to be more than 0 μm/s^{0.5} and 100 μm/s^{0.5} or less.

17. A method for producing a laminate which includes a porous substrate and a membrane formed of a membrane-forming composition and disposed on the porous substrate, wherein the membrane is formed by applying a membrane-forming composition which comprises a silicone, a solvent for dissolving the silicone, and microparticles and which exhibits a permeation speed through the porous substrate of more than 0 μm/s^{0.5} and 100 μm/s^{0.5} or less, the permeation speed being determined by the Lucas-Washburn equation.
